(19) United States
(12) Patent Application Publication
(10) Pub. No.: US 2007/0097418 A1
(43) Pub. Date: May 3, 2007

(54) Job management system and program for the same

(76) Inventor: Keizen Kanazawa, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,882

(22) Filed: Oct. 27, 2005

(51) Int. Cl. G06F 3/12

(52) U.S. Cl. 358/1.15

(57) ABSTRACT

To solve the foregoing problems, the invention includes an intermediate data creation means for creating intermediate data, in an intermediate language that can be restored, of job data that have been created by an application, a restore determining means for determining whether restoration by the application is possible based on the intermediate data that have been created by the intermediate data creation means, and a developing means for developing the job data on a predetermined application depending on the result of the determination by the restore determining means.

### FIELD OF THE INVENTION

The present invention relates to job management systems, and in particular to job management systems for managing the saving and outputting of jobs handled by host machines and printing devices.

The present invention also relates to storage media storing a program for causing a computer to execute the processing on the job management system.

### BACKGROUND INFORMATION

Conventionally, when printing documents, etc., created by a predetermined application of a host machine on a paper medium, the job data of that document is transmitted to a specific printing device connected to the host machine and temporarily saved on the printing device before printing is executed. Users then walk over to that specific printing device to pick up the printed material. Users also may operate a panel provided on the printing device to print the job data saved on the printing device to a paper medium. However, once job data have been saved the data are fixed, and it was not possible to use dedicated utility software to edit the job data by correcting or changing the data. Further, to confirm the content of the saved job data, the job data were actually printed to a paper medium.

One example of a conventional technology for handling printing device jobs is a printing device that recognizes print data that it has stored independently for the user as shared data, and prints the predetermined print data directly.

There also are print information distribution systems in which page layout data are converted to a PDF (Portable Document Format) on the host-side and then that PDF is transmitted to a terminal device to be edited and printed.

There also are print systems that separate print data into printer setting data and page descriptive language data, and then convert the page descriptive language data into an intermediate descriptive language that can be edited.

Further, there also are print data processing devices that hold and edit intermediate data that have been created by an application and then convert those intermediate data into printable data and transmit them to a printing device.

However, these conventional technologies have the problem that to review the content of saved job data the user was forced to walk to a distant printing device because the job is printed by only the specific printing device storing that job, and this requires effort and time and is inconvenient.

Further, when the user would like to review job data, he was forced to print it on paper first, and this wastes paper.

Further, conventional technologies also have the problem that when dedicated utility software is used to temporarily store job data on a host machine or printing device, the user cannot edit the print data prior to printing, and thus lack general utility.

Accordingly, it is an object of the invention to provide a job management system with which job data can be reviewed and edited prior to printing, thereby increasing the convenience and generally utility when handling jobs.

### SUMMARY OF THE INVENTION

To solve the foregoing problems, the invention is a job processing system for managing the handling of jobs to be executed by a printing device, the system including an intermediate data creation means for creating intermediate data, in an intermediate language that can be restored, of job data that have been created by an application, a restore determining means for determining whether the intermediate data that have been created by the intermediate data creation means can be restored by the application, and a developing means for developing the job data with a predetermined application depending on the result of the determination by the restore determining means.

With this job management system, intermediate data for job data that have been created by an application are created in an intermediate language that can be restored, and whether or not the intermediate data can be restored by the application is determined based on the intermediate data, and by developing the job data with a predetermined application according to the result of that determination, the job data can be printed on another printing device using the intermediate data and the job content can be reviewed and edited before printing. Thus, the convenience and general utility when handling job data are increased.

In the invention, it is also possible for the intermediate data that have been created by the intermediate data creation means to have identifying information for identifying the application of the job data.

With this job processing system, the intermediate data are given identifying information for identifying the application so that the intermediate data can be developed for that application and printed, and this allows the convenience and general utility when handling jobs to be increased.

In the invention, it is also possible for the job processing system to further include a supplying means for supplying the intermediate data that have been created by the intermediate data creation means to a predetermined printing device or host machine.

With this job processing system, the intermediate data can be supplied to a predetermined printing device or host machine so that the user can print and review/edit the job data at a nearby printing device.

In the invention, it is also possible for the job processing system to further include a display input means that can display and edit the content of the job data based on the intermediate data.

With this job processing system, the job management system is provided with a display input means that allows the content of the job data to be displayed and edited based on the intermediate data so that the job content can be reviewed and edited before printing, and this allows the convenience and general utility when handling jobs to be increased.

In the invention, it is also possible for the intermediate language to be the PDF and PDL format.

With this job processing system, the intermediate language is a PDF/PDL format so that the job content can be reviewed and edited with ease, thereby allowing the convenience and general utility when handling jobs to be increased.

The invention also includes storage medium storing a program for causing a computer to execute the processing of a job processing system for managing the saving and outputting of jobs to be executed by a printing device, where the program causes the computer to execute an intermediate data creation procedure of creating intermediate data, in an intermediate language that can be restored, of job data that have been created by an application, a restore determining procedure of determining whether restoration by the application is possible with the intermediate data that have been created in the intermediate data creation procedure, and a developing procedure of developing the job data with a predetermined application depending on the result of the determination in the restore determining procedure.

With this job management system, intermediate data for job data that have been created by an application are created in an intermediate language that can be restored, whether or not the intermediate data can be restored by the application is determined based on the intermediate data, and the job data are developed by a predetermined application according to the result of that determination, and thus the job data can be printed on another printing device using the intermediate data and the job content can be reviewed and edited before printing. Thus, the convenience and general utility when handling job data is increased.

The invention also may be a program for causing a computer to execute the job management process and a storage medium storing that program.

With the present invention, intermediate data that correspond to an application are created and whether or not the job data can be restored on a predetermined printing device is determined from the print data and the intermediate data are developed accordingly, and thus the job content can be reviewed and edited before printing and the convenience and general utility when handling job data is increased.

### BRIEF DESCRIPTION OF THE SEVERAL VIEWS OF THE DRAWINGS

FIG. 1 is a structural diagram showing the job management system according to an embodiment of the invention.

FIG. 2 is a flowchart showing the job management process.

### DETAILED DESCRIPTION OF THE PREFERRED EMBODIMENTS

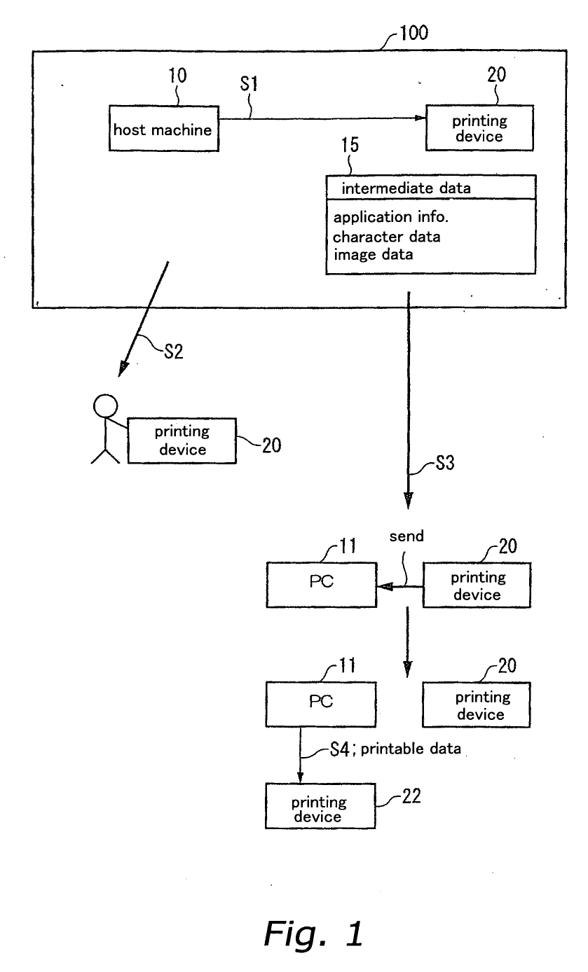

Embodiments of the invention are described below with reference to the drawings. FIG. 1 is a structural diagram showing the job management system according to one embodiment of the invention. In FIG. 1, a job management system 100 is a system that is primarily made of a host machine 10 that outputs job data that have been created for printing, and a printing device 20 for executing printing based on the job data that have been output from the host machine 10. The host machine 10 and the printing device 20 are connected over a network such as a LAN, and send and receive job data and intermediate data 15, which are created based on the job data, to and from one another.

The host machine 10 shown in FIG. 1 creates intermediate data 15 according to job data that have been created by a plurality of applications. The host machine 10 transmits the job data and the intermediate data 15 that have been created to the printing device 20. It should be noted that the intermediate data 15 are created in an intermediate language such as PDF (trade name), and are made of application information on when the job was created, character data, or image data, for example.

The host machine 10 is a personal computer (PC hereinafter) whose components are controlled by a CPU (central processing unit). The CPU performs a job management process according to a program for executing the invention that is stored on a memory unit. The flow of the procedure up to execution of the job management process is described below. For example, a job management process program stored on a recording medium (not shown) is read by an installer in the host machine 10 and installed on an auxiliary storage device, for example. When the job management process, which will be discussed later, is activated, the CPU starts that process according to the program, which has been installed on the auxiliary storage device. It should be noted that the recording medium is a computer-readable medium that can store the program, such as a CD-ROM. It is also possible for the job management process to be performed on the printing device 20.

The printing device 20 includes a storage medium for storing job data that have been supplied from the host machine 10, a driver for controlling the printing device 20, and a printing portion for printing the job content on a paper medium. The printing device 20 stores the job data and the intermediate data that have been sent from the host machine 10 on its storage medium. The printing portion executes printing based on the job data and the intermediate data that have been saved.

The host machine 10 and the printing device 20 both are provided with a display input terminal (not shown) that allows the content of job data to be freely reviewed and edited. The display input terminal allows users to freely review the content of the job data and the procedure of the printing, for example, and to change and correct the job data content before printing by the printing device 20.

The job management process is described below.

First, the host machine 10 creates intermediate data according to the job data that have been created by a predetermined application, and transmits the job data and the intermediate data 15 to the printing device 20 (step S1).

For example, when the user would like to review the job content on the printing device 20, he operates a panel or the like on the printing device 20 to review and edit the intermediate data 15 and the job data (step S2). If necessary, he can cause a printing device 21 to output the job data. The user can also print job data using a dedicated utility, for example.

The printing device 20 also sends the intermediate data to another PC 11, which is a host machine, over the network. The PC 11 takes the intermediate data 15 and restores them the original data prior to becoming printable data (step S3). Data that have been restored by the PC 11 can be transmitted to a printing device 22 that is nearest the user and printed (step S4).

When the PC 11 determines, from the application information of the intermediate data 15 that it has received, that it does not have the application with which to perform this restoration, it also can restore and edit the data using a general restoring software program.

In this way, users can operate the panel, for example, of the printing device 20 or a printing device 22 that is located near them to review and edit the intermediate data 15 and the job data. It is also possible to use the intermediate data 15 that have been transmitted to the other PC 11 to restore and print the original data before becoming printable data, and this increases the convenience and utility when handling jobs.

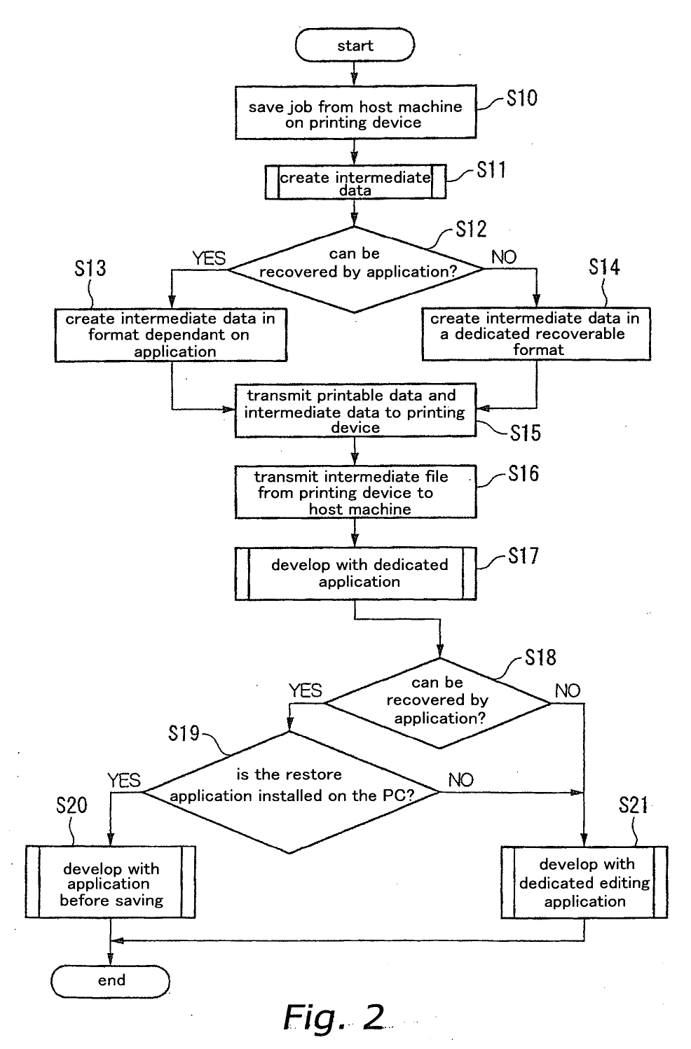

An example of the job management process executed by the host machine 10 and the printing device 20 is described next. FIG. 2 is a flowchart showing the job management process. In FIG. 2, first, in step S10, the host machine 10 sends job data to the printing device 20, which saves the job data. It should be noted that the job data include identifying information for identifying the application used to create the data on the host machine 10. In step S11, the host machine 10 creates intermediate data according to the job data that have been sent. In step S12, the host machine 10 determines whether there is an application that is capable of restoring the intermediate data, based on the identifying information of the job data and the intermediate data. If in step S12 it is determined that the application can restore the intermediate data, then in step S13 the host machine 10 creates intermediate data in a format that is dependant on the application. If in step S12 it is determined that the application cannot restore the intermediate data, then in step S14 the host machine 10 creates the intermediate data in a dedicated restorable format (or application).

In step S15, the host machine 10 transmits the printable data and the job data to use when printing to the printing device 20. In step S16, the host machine 10 (or the PC 11) transmits the intermediate data to the printing device 20. In step S17, the host machine 10 (or the PC 11) develops the job content with a dedicated application based on the intermediate data. In step S18, the host machine 10 (or PC 11) determines whether the application can restore the intermediate data. If it is determined in step S18 that the application can restore the data, then in step S19 the host machine 10 (or the PC 11) determines whether the determined application is installed on the host machine 10. If it is determined in step S19 that the determined application has been installed, then in step S20 the host machine 10 (or the PC 11) develops the intermediate data with the application before saving.

If it is determined in step S18 that the application cannot restore the data, then in step S21 the host machine 10 (or the PC 11) develops the intermediate data with a dedicated editing application. On the other hand, if it is determined in step S19 that the application that has been determined is not installed, then the process of step S21 is performed and the job management process is ended. It should be noted that the various steps of the job management process can be executed by either the host machine 10 or the printing device 20.

In this way, the host machine 10 creates intermediate data in a restorable intermediate language for job data that have been created by an application, whether or not the job data can be restored by the application is determined based on the intermediate data that have been transmitted to the printing device 20, and the job data are developed by a predetermined application according to the result of that determination and used to execute printing, and thus users do not have to walk to a specific printing device and instead can transmit the intermediate data to a nearby printing device and print the job data on that printing device. By creating intermediate data that are compatible with a variety of applications, the job content can be efficiently reviewed and edited even after job data and intermediate data have been stored on the printing device. Further, the job data can be restored and printed using a dedicated editing application, etc. on other printing devices that do not include the application for the job data.

What is claimed is:

1. A job processing system for managing the handling of jobs to be executed by a printing device, comprising:
an intermediate data creation means for creating intermediate data, in an intermediate language that can be restored, of job data that have been created by an application;
a restore determining means for determining whether the intermediate data that have been created by the intermediate data creation means can be restored by the application; and
a developing means for developing the job data with a predetermined application depending on the result of the determination by the restore determining means.

2. The job processing system according to claim 1,
wherein the intermediate data that have been created by the intermediate data creation means have identifying information for identifying the application of the job data.

3. The job processing system according to claim 1, further comprising:
a supplying means for supplying the intermediate data that have been created by the intermediate data creation means to a predetermined printing device or host machine.

4. The job processing system according to claim 1, further comprising:
a display input means that can display and edit the content of the job data based on the intermediate data.

5. The job processing system according to claim 1,
wherein the intermediate language is PDF and PDL format.

6. A storage medium storing a program for causing a computer to execute the processing of a job processing system for managing the saving and outputting of jobs to be executed by a printing device;
wherein the program causes the computer to execute:
an intermediate data creation procedure of creating intermediate data, in an intermediate language that can be restored, of job data that have been created by an application;
a restore determining procedure of determining whether restoration by the application is possible with the intermediate data that have been created in the intermediate data creation procedure; and
a developing procedure of developing the job data with a predetermined application depending on the result of the determination in the restore determining procedure.
